(19) United States
(12) Patent Application Publication
(10) Pub. No.: US 2026/0172267 A1
(43) Pub. Date: Jun. 18, 2026

(54) CERTIFICATE AUTHORITY BASED OWNERSHIP FOR SECURE DEVICE ONBOARDING

(71) Applicant: Dell Products L.P., Round Rock, TX (US)

(72) Inventors: Bradley K. Goodman, Nashua, NH (US); Joseph B. Caisse, Burlington, MA (US); Eric Bruno, Shirley, NY (US)

(73) Assignee: Dell Products L.P., Round Rock, TX (US)

(21) Appl. No.: 19/239,649

(22) Filed: Jun. 16, 2025

Related U.S. Application Data
(60) Provisional application No. 63/733,988, filed on Dec. 13, 2024.

(51) Int. Cl. H04L 9/32

(52) U.S. Cl. CPC H04L 9/3268

(57) ABSTRACT

Systems and methods for certificate authority (CA) based ownership for secure device onboarding are described. In an illustrative, non-limiting embodiment, an Information Handling System (IHS) may include: a processor and a memory coupled to the processor, the memory having program instructions stored thereon that, upon execution by the processor, cause the IHS to: receive, at an onboarding service, an ownership voucher that includes a name corresponding to a prospective owner of a device; obtain, by the onboarding service, a certificate issued by a CA; validate, by the onboarding service, the name in the ownership voucher against a name in the certificate to establish device ownership by the prospective owner; and onboard the device upon successful validation.

### CROSS-REFERENCE TO RELATED APPLICATIONS

This application claims the benefit of U.S. Provisional Patent Application No. 63/733,988, filed on Dec. 13, 2024 and titled “Certificate Authority Based Ownership for Secure Device Onboarding,” the disclosure of which is hereby incorporated by reference herein in its entirety.

### FIELD

This disclosure relates generally to Information Handling Systems (IHSs), and more specifically, to systems and methods for certificate authority (CA)-based ownership for secure device onboarding.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for certificate authority (CA) based ownership for secure device onboarding are described. In an illustrative, non-limiting embodiment, an Information Handling System (IHS) may include: a processor and a memory coupled to the processor, the memory having program instructions stored thereon that, upon execution by the processor, cause the IHS to: receive, at an onboarding service, an ownership voucher that includes a name corresponding to a prospective owner of a device; obtain, by the onboarding service, a certificate issued by a CA; validate, by the onboarding service, the name in the ownership voucher against a name in the certificate to establish device ownership by the prospective owner; and onboard the device upon successful validation.

In some implementations, the certificate may include a custom x509 extension that defines an ownership scope. The certificate may also include a Domain Name System (DNS) name corresponding to the name.

To validate the name in the ownership voucher against the name in the certificate, the onboarding service may be configured to check a certificate chain. Additionally, or alternatively, to validate the name in the ownership voucher against the name in the certificate, the onboarding service may be configured to check a certificate revocation status.

The device may be onboarded independently of any private cryptographic credentials managed by the prospective owner. The onboarding service may be configured to support a plurality of trusted CAs to mitigate risks associated with CA revocation.

The ownership voucher may include a plurality of names corresponding to multiple prospective owners, and the onboarding service may be configured to validate ownership for each name using respective certificates. The onboarding service may be configured to reissue certificates for the device in response to a certificate expiration or revocation without modifying the ownership voucher.

The onboarding service may be configured to utilize intermediate CAs to issue certificates. The onboarding service may be configured to onboard the device using a certificate that includes wildcard Domain Name System (DNS) names to define ownership scope across subdomains. The onboarding service may be configured to store a record of the validation, including the certificate chain and revocation status, for auditing purposes.

The onboarding service may be configured to support dynamic specification of CAs within the ownership voucher. The onboarding service may be configured to onboard the device using a certificate comprising an x509 extension specifying ownership scope. The onboarding service may allow coexistence of CA-based ownership and private cryptographic credential-based ownership mechanisms.

In another illustrative, non-limiting embodiment, a memory device may have program instructions stored thereon that, upon execution by a processor of a device, cause the device to: generate an ownership voucher that includes a name corresponding to a prospective owner of the device; transmit the ownership voucher to an onboarding service; receive a certificate issued by the onboarding service and attested by a CA; validate the certificate; determine that the name in the ownership voucher matches a name in the certificate; and establish trust with the onboarding service in response to the determination.

In yet another illustrative, non-limiting embodiment, a method may include: receiving an ownership voucher that includes a name corresponding to a prospective owner of a device; obtaining a certificate issued by a CA; validating the name in the ownership voucher against a name in the certificate to establish device ownership by the prospective owner; and onboarding the device upon successful validation. The device may be onboarded independently of any private cryptographic credentials managed by the prospective owner.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram of examples of components of an Information Handling System (IHS), according to some embodiments.

FIGS. 2 and 3 are diagrams comparing key and name-based device onboarding methods, according to some embodiments.

FIGS. 4 and 5 are diagrams comparing the use of fixed and dynamically specified root certificate authorities (CAs) for secure device onboarding, according to some embodiments.

FIGS. 6 and 7 are flowcharts of examples of methods for secure device onboarding, according to some embodiments.

### DETAILED DESCRIPTION

Systems and methods described herein relate to device onboarding, with particular emphasis on the assignment and validation of device ownership in a manner that promotes strong security, operational scalability, and ease of management. As the modern world increasingly relies on interconnected digital devices across commercial, industrial, and personal environments, the need for secure integration of each device into a trusted network becomes paramount. Secure device onboarding confirms the authenticity of a device's identity and establishes its authorization before it engages in sensitive operations, thereby maintaining system integrity and enabling efficient management of hardware assets.

As used herein, the term “device onboarding” refers to the process of securely integrating a device into a network or system environment by establishing its identity, validating its ownership, and authorizing its participation in the network. Device onboarding properly authenticates and associates a device with its rightful owner before it is granted access to network resources or allowed to perform operations within the system. This process typically involves the exchange of ownership credentials, validation of certificates issued by trusted entities, and/or the establishment of trust between the device and the onboarding service.

An “ownership voucher” is a secure digital document that specifies the ownership of a device and serves as the foundational credential for validating and transferring ownership during the onboarding process. An ownership voucher includes information that uniquely identifies the device and its prospective owner, such as a name, domain, or other identifier. It may also include cryptographic elements, such as signatures or certificates, that attest to the authenticity of the ownership information. An ownership voucher is typically generated by the device or its manufacturer and is transmitted to an onboarding service to facilitate the validation of ownership and the secure integration of the device into a network environment.

The term “ownership scope” refers to the boundaries or limits within which a device's ownership is defined and validated during the onboarding process. Ownership scope specifies the entity or entities authorized to claim ownership of a device and manage its integration into a network environment. Ownership scope may be used to make sure that devices are onboarded only by entities that have been explicitly authorized to act within the defined boundaries.

The term “public key” refers to a cryptographic key that is part of a public-private key pair and is used in asymmetric encryption systems. A public key is openly shared and can be used by other entities to encrypt data or verify digital signatures created by a corresponding private key. Public keys are typically distributed through certificates issued by trusted certificate authorities (CAs) to guarantee their authenticity and integrity. In the context of device onboarding, public keys may be used to validate ownership credentials or establish secure communication channels between devices and onboarding services.

Conversely, a “private key” is a cryptographic key that is the counterpart to the public key in a public-private key pair. A private key is kept secret and is used to decrypt data encrypted with a corresponding public key or to create digital signatures that can be verified using the public key. Private keys are critical for maintaining the security of cryptographic systems, as their compromise can lead to unauthorized access or data breaches.

The term “Certificate Authority” (CA) refers to a trusted entity responsible for issuing, managing, and revoking digital certificates used in public key infrastructure (PKI) systems. A CA serves as a central authority that verifies the identity of entities requesting certificates and attests to their authenticity by digitally signing the certificates it issues. These certificates typically include a public key, identifying information about the entity, and metadata such as expiration dates and usage constraints.

In the context of device onboarding, a CA plays a critical role in validating ownership by issuing certificates that define ownership scope and authorize onboarding services to act on behalf of the named owner. Trusted root CAs are often pre-installed in devices, enabling them to verify certificates issued by intermediate CAs or onboarding services. The hierarchical trust model established by CAs enables devices to securely integrate into network environments by relying on certificates that are traceable to a trusted root CA. Additionally, CAs support mechanisms such as the Online Certificate Status Protocol (OCSP) and Certificate Revocation Lists (CRLs) to manage certificate revocation and maintain the integrity of the trust model.

The term “FIDO Device Onboarding” (FDO) refers to a secure protocol developed by the FIDO Alliance to facilitate the onboarding of devices into network environments. It focuses on eliminating reliance on passwords by enabling secure, user-friendly authentication methods such as biometrics, hardware tokens, and public key cryptography.

Conventional onboarding methodologies, such as those employed in FDO, typically rely on ownership vouchers that transfer control via a chain of private cryptographic elements. This process originates with a manufacturing key embedded during production and progresses through successive entities, with each party using its private key to sign a statement transferring ownership to the next entity's public key. Ultimately, ownership is assigned to the final customer during late-stage, in-field deployment.

The inventors hereof have recognized, however, that conventional methodologies place substantial responsibility on end-customers to implement and maintain effective key management practices. Such practices frequently demand specialized infrastructure, such as hardware security modules (HSMs), and expertise that many users or organizations lack. Most end-customers are ill-suited to assume responsibility for root-level key management, as they may not possess the operational capabilities required to safeguard private keys, respond to loss or compromise, or maintain the integrity of onboarding credentials. Even organizations responsible for high-value systems and infrastructure may fall short of the stringent operational security required to manage cryptographic credentials at this level.

These challenges are further magnified in large-scale deployments, where managing the lifecycle of individualized credentials (issuance, distribution, rotation, and revocation) becomes increasingly complex. The risks related to key loss, theft, or compromise may lead to system vulnerabilities, extensive remediation efforts, or even loss of control over deployed devices. In the best case, such events require regeneration of keys and reissuance of ownership vouchers; in the worst case, they may enable unauthorized control by malicious actors.

To address these, and other concerns, systems and methods described herein improve secure device onboarding systems by reducing or eliminating reliance on customer-owned private keys for ownership assignment. To that end, these systems and methods introduce a framework that replaces the use of private cryptographic elements with a certificate authority (CA)-based model. In this approach, ownership may be represented by verifiable “names,” such as DNS domains, rather than by direct possession of cryptographic secrets.

The association between a device and its rightful owner may be validated through certificates issued by trusted root CAs. This allows onboarding services to demonstrate authorization via possession of appropriate certificates, eliminating the need for end-customers to manage private keys directly and reducing the risk of credential compromise. In various embodiments, these techniques may alleviate the administrative burden on end-users while improving flexibility and scalability in device onboarding.

In some cases, these systems and methods may use custom x509 extensions to define ownership scope, support for intermediate CAs to enable organizational flexibility, and/or mechanisms for certificate reissuance and revocation without requiring modifications to endpoint ownership vouchers. Additionally, multiple Root CAs within ownership vouchers may be included to mitigate the impact of potential CA revocations.

As such, systems and methods described herein offer a secure, scalable, and user-friendly alternative to traditional onboarding mechanisms. By simplifying credential handling, mitigating operational risks, and leveraging trusted public keys, these systems and methods may enable seamless and resilient onboarding of devices into secure network environments.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

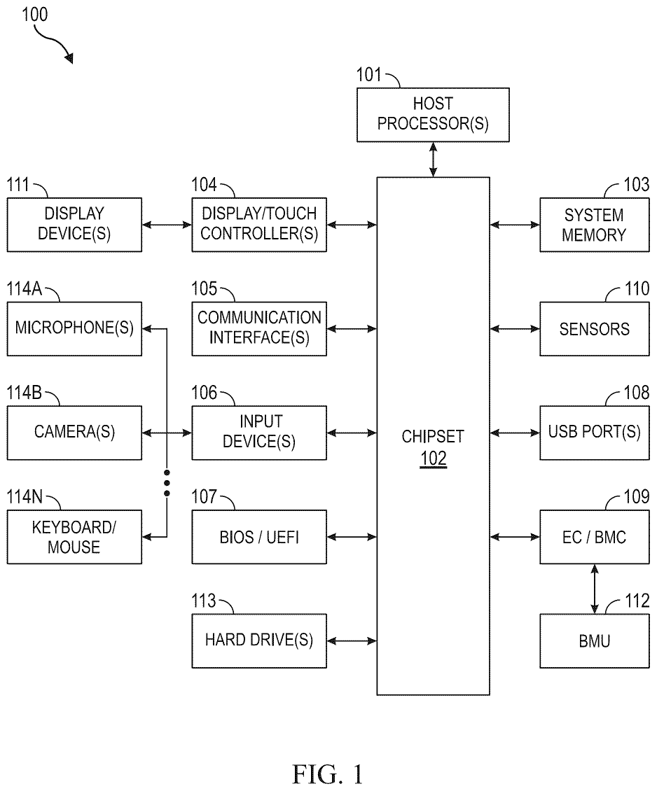

To illustrate this, FIG. 1 is a block diagram of components of IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as Ethernet, WiFi, BT, cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, microphones, headsets, etc.). Moreover, communication interface(s) 105 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provides video or display signals to one or more display device(s) 111.

Display device(s) 111 may include Liquid Crystal Display (LCD), Light Emitting Diode (LED), organic LED (OLED), or other display technologies. Display device(s) 111 may include a plurality of pixels arranged in a matrix, configured to display visual information, such as text, two-dimensional images, video, three-dimensional images, etc. In some cases, display device(s) 111 may be provided as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 108, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 113.

Chipset 102 may also provide access to one or more input devices 106, for example, using a super I/O controller or the like. Examples of input devices 106 include, but are not limited to, microphone(s) 114A, camera(s) 114B, and keyboard/mouse 114N. Other input devices 106 may include a touchpad, stylus or active pen, totem, etc. Each input device 106 may include a respective controller (e.g., a touchpad may have its own touchpad controller) that interfaces with chipset 102 through a wired or wireless connection (e.g., via communication interfaces(s) 105).

In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensors 110 may be disposed on or within the chassis of IHS 100, or otherwise coupled to IHS 100, and may include, but are not limited to: electric, magnetic (including magnetometer), radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), acceleration, ambient light, air particle, external temperature, and humidity sensors, among others.

BIOS 107 is coupled to chipset 102. UEFI was designed as a successor to BIOS, and many modern IHSs utilize UEFI in addition to or instead of a BIOS. Accordingly, BIOS 107 is intended to also encompass a UEFI component. BIOS 107 provides an abstraction layer that allows the OS to interface with certain hardware components that are utilized by IHS 100.

Upon booting of IHS 100, host processor(s) 101 may utilize program instructions of BIOS 107 to initialize and test hardware components coupled to IHS 100, and to load a host OS for use by IHS 100. Via the hardware abstraction layer provided by BIOS 107, software stored in system memory 103 and executed by host processor(s) 101 can interface with I/O devices coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101.

Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote or Out-of-Band (OOB) management, diagnostics, and remediation over network(s) 103, etc.

Unlike other devices in IHS 100, EC 109 may be made operational from the very start of each power reset, before other devices are fully running or powered on. As such, EC 109 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

EC 109 may also have direct access to General Purpose Input/Output (GPIO) interfaces, allowing it to communicate directly with sensors 110 and other devices. This access enables EC 109 to reset devices, control power states, and manage power rails, so that devices may be powered on or off as needed. This capability allows EC 109 to perform critical operations such as isolating faulty components, managing power distribution, and maintaining optimal device performance across various operational states. Within IHS 100, the EC's hardware and firmware access typically extend beyond what the host OS and BIOS can achieve, enabling it to execute low-level operations and manage hardware components directly.

In some cases, EC 109 may implement operations for detecting certain changes to the physical configuration or posture of IHS 100 and managing other devices in different configurations of IHS 100. For instance, when IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

EC 109 may also be installed as a Trusted Execution Environment (TEE) component to the motherboard of IHS 100. Additionally, or alternatively, EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate the hash value for a component, and it may compare it against the reference hash value to determine if any modifications have been made to the component, thus indicating that the component has been compromised. As such, EC 109 may validate the integrity of hardware and software components installed in IHS 100.

In addition, EC 109 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an Alternating Current (AC) adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) and/or Power Supply Unit (PSU) 112 may be coupled to EC 109. BMU/PSU 112 may include an Analog Front End (AFE), storage (e.g., non-volatile memory), and a microcontroller. In some implementations, the microcontroller may enable monitoring and management capabilities, allowing it to regulate charging and power delivery, track power consumption metrics, and communicate relevant power-related data to other devices such as, for example, components of a heterogeneous computing platform. Although not explicitly shown as coupled to all components, BMU/PSU 112 typically provides power to devices within IHS 100.

In operation, examples of telemetry data collectible by a BMU may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), detected events, etc.

Meanwhile, BMU-detected events may include, but are not limited to: acceleration or shock events, transportation events, exposure to elevated temperature for extended time periods, high discharge current rate, combinations of battery voltage, battery current, and/or battery temperature (e.g., elevated temperature event at full charge and/or high voltage causes more battery degradation than lower voltage), etc.

Similarly, a PSU may collect and store operational data such as input and output power levels, power efficiency metrics, power rail voltage levels, transient response characteristics, power ripple, thermal performance, and fault conditions (e.g., overvoltage, undervoltage, overcurrent, short circuit protection events). A PSU may also track power source transitions, such as switching between AC and DC sources, record historical power usage patterns to assist in predictive maintenance and energy efficiency optimizations, and detect and log events such as: power surges, transient voltage fluctuations, thermal shutdown events, power supply unit failures, abnormal current draws, external power interruptions, load balancing adjustments, etc.

A PSU may further detect and log anomalies such as excessive power draw by specific components, prolonged high-power states that may indicate inefficiencies, and interactions between different power rails that may impact IHS stability. In some implementations, a PSU may communicate with a BMU within the same IHS 100 to coordinate power delivery strategies, to support transitions between battery and external power sources.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components shown in FIG. 1 (e.g., chipset 102, display controller(s) 104, communication interface(s) 105, EC 109, etc.) may be replaced by devices within a heterogenous computing platform. As such, IHS 100 may assume different form factors including, but not limited to: servers, workstations, desktops, laptops, appliances, video game consoles, tablets, smartphones, Internet-of-Things (IoT) devices, etc.

In various embodiments, IHS 100 may be used to implement one or more roles or functionalities within a secure device onboarding framework. These may include acting as the device being onboarded, a CA, or an onboarding service responsible for validating ownership and integrating devices into a secure network. IHS 100 may also function as an intermediate CA within an organizational hierarchy, issuing certificates to onboarding services and enabling granular control over device onboarding. Additionally, IHS 100 may implement systems for managing ownership vouchers, auditing and compliance, trust model management, network integration and security, and device lifecycle management. IHS 100 may also support hybrid ownership mechanisms that allow coexistence of CA-based and key-based ownership models, providing flexibility and compatibility with existing systems.

Certain embodiments described herein may provide secure device onboarding by leveraging CA-based ownership, inspired by the trust model used in the World Wide Web. In web-based systems, users do not need specific knowledge of the cryptographic keys for a site; instead, they rely on a list of trusted root CAs. If a site can prove, via Transport Layer Security (TLS) or similar protocols, that its server has been attested by a known root CA, the user trusts the site. Similarly, certain embodiments may replace traditional cryptographic key-based mechanisms with a name-based ownership model validated by certificates issued by trusted root CAs.

Systems and methods described herein may be implemented by building endpoints with well-known root CAs. Instead of assigning or transferring ownership to a cryptographic key, ownership may be specified by a name, such as a DNS domain. Upon verification, an onboarding service does not need to prove possession of the final owner key specified in the ownership voucher. Instead, the onboarding service may present a certificate that proves its key is authorized by a recognized root CA to onboard devices on behalf of the named owner.

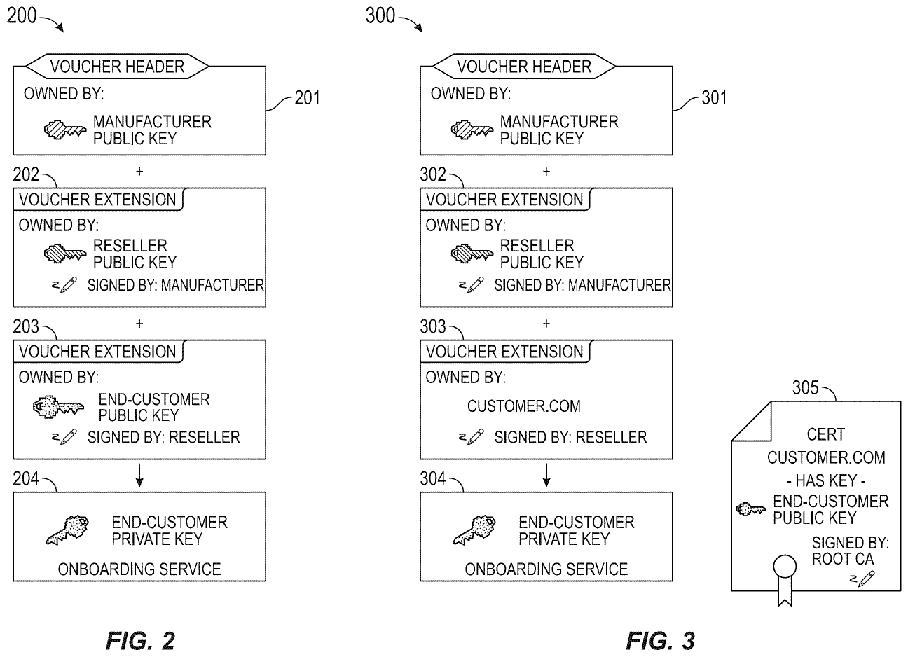

In FIG. 2, method 200 illustrates a traditional device onboarding process that relies on a chain of cryptographic keys to transfer ownership from the manufacturer to the end-customer. The process begins with the creation of an ownership voucher, which serves as the foundational document for validating and transferring ownership. Voucher header 201 includes the manufacturer's public key, which is used to establish the initial ownership of the device.

The ownership voucher is then extended as the device changes hands. Voucher extension 202 includes the reseller's public key, which is signed by the manufacturer using its private key. This cryptographic signature attests to the authenticity of the reseller's public key and establishes the reseller as the next entity in the ownership chain. Similarly, voucher extension 203 includes the end-customer's public key, which is signed by the reseller using its private key. This signature validates the transfer of ownership from the reseller to the end-customer, completing the ownership chain.

At the final stage, onboarding service 204, which is responsible for securely integrating the device into the network environment, relies on the end-customer's private key to authenticate the device and establish ownership. The onboarding service verifies the chain of signatures in the ownership voucher, so that each transfer of ownership is valid and traceable back to the manufacturer. Once the end-customer's private key is validated, the onboarding service completes the onboarding process by associating the device with the end-customer and granting it access to the network.

In contrast to the traditional onboarding process illustrated in FIG. 2, method 300 of FIG. 3 introduces a CA-based ownership model that replaces the reliance on cryptographic keys with a name-based ownership protocol. This approach simplifies the onboarding process by using names, such as DNS domains, to define ownership, which are validated through certificates issued by trusted root CAs.

Particularly, method 300 begins at 301, where the ownership voucher is created with a voucher header that includes the manufacturer's public key, establishing the initial ownership of the device. At 302, the ownership voucher is extended to include the reseller's public key, signed by the manufacturer using its private key. This cryptographic signature attests to the authenticity of the reseller's public key and establishes the reseller as the next entity in the ownership chain.

At 303, instead of extending the ownership voucher with the end-customer's public key, the voucher extension includes a name, such as “customer.com,” which represents the ownership scope. This name is signed by the reseller using its private key, attesting to the transfer of ownership to the named entity. The use of names, rather than cryptographic keys, simplifies the ownership assignment process and reduces the burden on the end-customer to manage private keys.

At 304, the onboarding service, which is responsible for securely integrating the device into the network environment, possesses the end-customer's private key and a certificate issued by a trusted CA. This certificate, signed by a root CA, indicates that the name “customer.com” is associated with the end-customer's public key. The onboarding service uses this certificate to validate its authorization to onboard devices on behalf of the named owner. Unlike method 200, the onboarding service does not need to prove possession of the end-customer's private key directly; instead, it demonstrates its authority through the certificate issued by the CA.

This approach may be referred to as a “named owner” protocol, where ownership is specified by a name rather than a cryptographic key. A name may be as simple as a company name. If a recognized Root CA generates a certificate specifying a given name, an endpoint assigned to that name may be onboarded by a service that possesses a key in that certificate.

A name may theoretically be any identifier, as long as the ownership voucher and certificate match names. For manageability and security reasons, the name may be a well-established DNS name or subdomain, with optional wildcards. The issuing root CA verifies that the domain name specified in the certificate is owned and controlled by the entity receiving the certificate.

For example, x509 Subject Alternative Names (SANs) may allow specifying a list of optionally wildcarded DNS names. This convention enables organizations to scope certificates in a manner that allows them to create subdomains or separate estates within their organization, each with its own certificate chain for onboarding. An organization may request a root CA to issue certificates for the organization as a whole or for specific sub-estates or subdomains, after which the organization is responsible for managing the sub-estates.

As SANs are specified via x509 extensions, a similar mechanism may define ownership scope. For example, a certificate may specify an ownership scope using DNS names such as “example.com” or wildcard domains like “*.example.com,” indicating that the entity controlling these domains is authorized to onboard devices associated with them. Ownership scope may also be defined hierarchically, allowing organizations to delegate onboarding authority across subdomains or estates within their operational structure.

In the context of certificate authority-based ownership, ownership scope is validated using certificates that include custom x509 extensions specifying the scope. For example:
X509v3 extensions:
1.2.3.4.5.6.7.8:
critical
example.com, onboard.example.com, *.estates.example.com

The Object Identifier (OID) may be globally well-defined and universally unique, as specified by applicable onboarding standards such as FDO. The name format may follow a standard, comma-separated set of DNS names, placing responsibility on root CAs to issue certificates only to entities verified to control the specified DNS names and on domain owners to manage subdomains and sub-estates under their control. The critical flag in the extension indicates that any application processing the certificate, including certificate issuers and onboarding applications, must understand the implications of trusting the data specified in the certificate.

Following standard certificate practices, a root CA typically issues certificates to intermediate CAs owned by organizations rather than directly to individual onboarding services. These intermediate CAs may then issue certificates to multiple onboarding services within the organization. Certificates issued by intermediate CAs may be scoped to allow specific onboarding services to onboard endpoints assigned to specific domains or sub-estates. This hierarchical structure enables flexibility and scalability, allowing certificates to be scoped broadly for the entire organization or more granularly for specific subdomains.

An advantage of this design is its ability to handle key loss without requiring changes to ownership vouchers. If an owner key is lost, a new key and certificate may be generated, allowing onboarding to continue. Depending on the key being re-minted, this may require the company to reissue new onboarding service certificates with its own intermediate key or, in the case of losing intermediate keys, request a Root CA to issue new intermediate certificates. Even if thousands of endpoints are under management, only onboarding service or intermediate certificates need to be reissued, rather than potentially thousands of ownership vouchers. This reduces disruption and simplifies recovery in worst-case scenarios.

A drawback of method 200 using direct keying is the lack of a mechanism to revoke keys. In contrast, in method 300, onboarding service and intermediate certificates may be verified and revoked using standard practices such as the Online Certificate Status Protocol (OCSP) or Certificate Revocation Lists (CRLs). Revoked certificates may be replaced with new ones, leveraging the hierarchical trust model of root CAs.

In some cases, ownership vouchers may specify selected root CAs in conjunction with the name during ownership voucher extension, rather than relying on globally trusted CAs built into devices. This narrows the scope of trust, ensuring that ownership is defined by specific CAs rather than any globally trusted CA. This approach also provides flexibility in defining ownership certificates. For example, a value-added reseller (VAR) may act as the root CA for devices it sells, independently of the OEM. This allows entities such as service providers to act as CAs for their customers, enabling customized trust models. The ability to specify multiple root CAs may also help in other scenarios, such as if a single root CA were to be revoked.

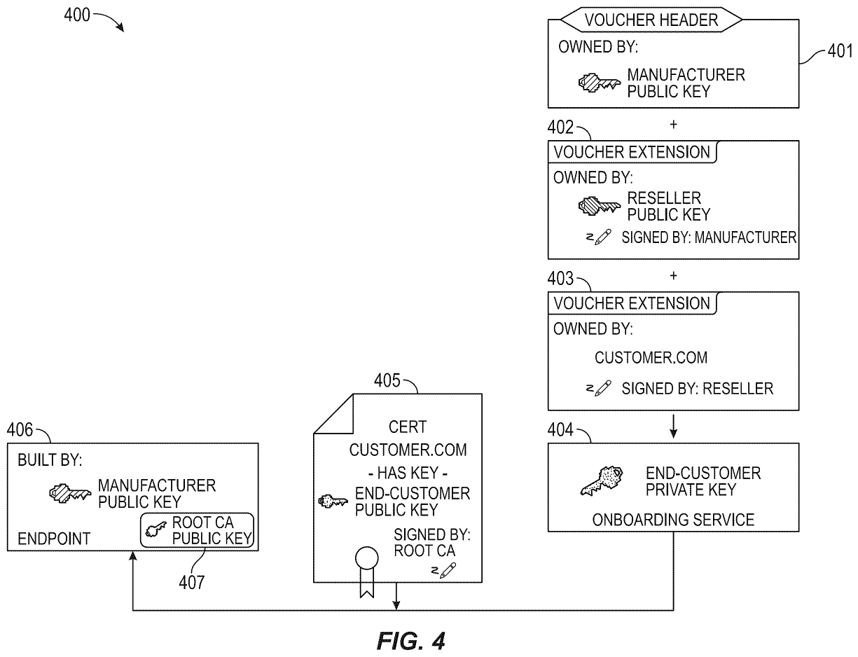

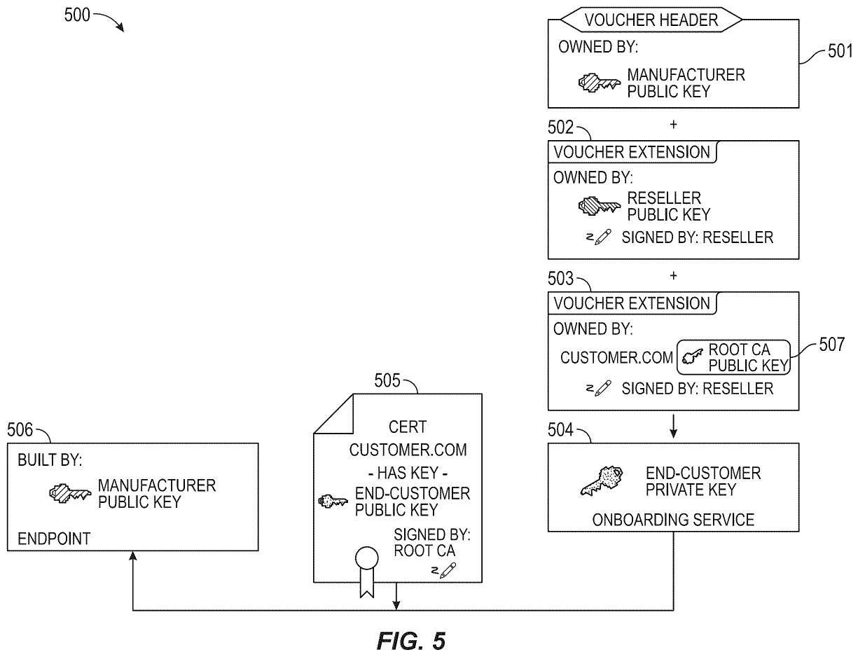

FIGS. 4 and 5 are diagrams of methods 400 and 500 comparing the use of fixed and dynamically specified root CAs for secure device onboarding, respectively. Particularly, at 401, the ownership voucher is created with a voucher header that includes the manufacturer's public key, establishing the initial ownership of the device in method 400. At 402, the ownership voucher is extended to include the reseller's public key, signed by the manufacturer using its private key. This cryptographic signature attests to the authenticity of the reseller's public key and establishes the reseller as the next entity in the ownership chain. At 403, the ownership voucher is further extended to include a name, such as “customer.com,” which represents the ownership scope. This name is signed by the reseller using its private key, attesting to the transfer of ownership to the named entity.

At 404, the onboarding service retrieves the manufacturer's public key 406, which has been signed by a fixed CA's public key 407. The fixed CA is a pre-determined certificate authority that is embedded in the device or specified in the onboarding process. This guarantees that the manufacturer's public key is authenticated by a trusted CA, providing a secure foundation for the onboarding process. Additionally, the onboarding service retrieves certificate 405, which is issued by the fixed CA and includes the necessary information to validate the ownership scope. The use of a fixed CA allows the onboarding process to rely on a consistent and pre-defined trust model, where the CA is explicitly known and trusted by the device and onboarding service.

In method 500, 501 and 502 correspond to 401 and 402 in method 400, describing the creation and extension of the ownership voucher with the manufacturer's public key and the reseller's public key, respectively. However, at 503, the voucher extension includes a root CA public key 507, rather than relying on a fixed CA. This introduces flexibility by allowing the ownership voucher to specify the root CA dynamically, rather than embedding a pre-determined CA in the device. This dynamic specification enables the onboarding process to adapt to different trust models or organizational requirements, where the root CA may be selected based on the specific needs of the deployment.

At 504 and 505, the onboarding service may retrieve the manufacturer's public key and the certificate issued by the CA. However, at 506, the onboarding process does not rely on a fixed CA public key. Instead, the CA is dynamically specified based on the root CA public key included in the ownership voucher. This dynamic specification allows the onboarding service to validate the ownership scope using a CA that is explicitly defined in the voucher, rather than relying on a globally trusted or pre-installed CA.

In sum, in method 400, the CA is fixed and pre-determined, ensuring a consistent trust model across all devices. In method 500, the CA is dynamically specified within the ownership voucher, providing greater flexibility and adaptability to different trust models or deployment scenarios. This dynamic approach allows organizations to define their own trust boundaries, such as using a value-added reseller (VAR) or service provider as the root CA. This may also be particularly useful in scenarios where customized trust models are required or where the revocation of a single root CA could impact the onboarding process.

In some embodiments, methods 300-500 do not preclude a device from being assigned ownership via the standard, existing key-based mechanism. Instead, they provide optional mechanisms that can be used at the discretion of the ultimate device owner and the services transferring ownership to that owner. This flexibility allows the coexistence of CA-based ownership and traditional key-based ownership mechanisms, ensuring compatibility with existing systems while introducing new capabilities.

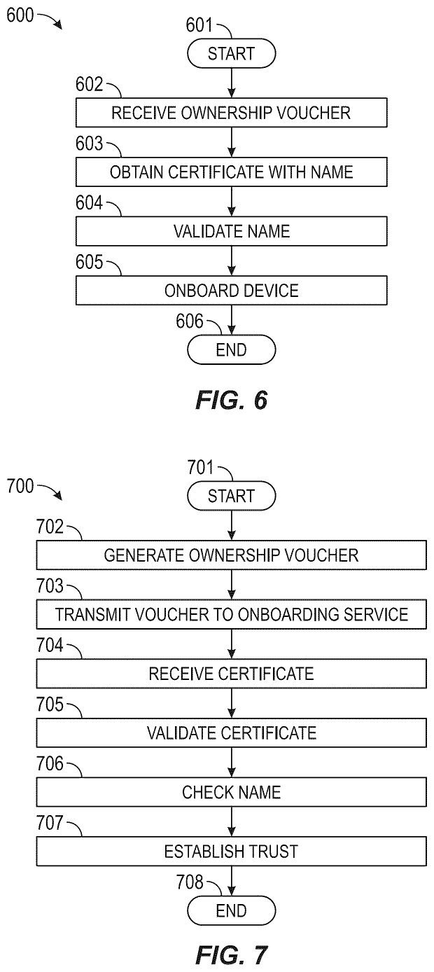

FIG. 6 illustrates method 600 for certificate authority-based ownership for secure device onboarding. Method 600 begins with initializing the onboarding process for a device, where the onboarding service is prepared to establish ownership and integrate the device into a secure network environment. At 601, the onboarding service receives an ownership voucher from the device. This ownership voucher may include a name corresponding to a prospective owner of the device, which may represent a DNS domain, subdomain, or other identifier specifying the ownership scope. The ownership voucher may serve as the foundational document for validating ownership during the onboarding process.

At 603, the onboarding service obtains a certificate issued by a trusted CA. The certificate may include a custom x509 extension defining the ownership scope, which specifies the boundaries of ownership using DNS names or wildcard DNS names. Additionally, the certificate may include a name corresponding to the prospective owner, which matches the name provided in the ownership voucher. The certificate is issued by a CA that is recognized and trusted by the onboarding service, ensuring that the ownership scope is properly attested.

At 604, the onboarding service then validates the name in the ownership voucher against the name in the certificate to establish device ownership. This validation process involves verifying the certificate chain associated with the certificate authority so that the certificate is properly signed and issued by a trusted CA. The onboarding service may also checks the certificate revocation status using OCSP or CRLs to confirm that the certificate has not been revoked. Upon successful validation, the onboarding service establishes device ownership by confirming that the name in the ownership voucher matches the name in the certificate.

At 605, once ownership is established, the onboarding service integrates the device into a secure network environment. This onboarding process may be performed independently of any private cryptographic credentials managed by the prospective owner, thereby reducing the burden on the owner to manage private keys. The onboarding service may use the validated certificate to authorize the device's participation in the network. Method 600 ends at 606 with the successful onboarding of the device.

In some implementations, the onboarding service may store a record of the validation process, including the certificate chain and revocation status, for auditing purposes. Additionally, the onboarding service may reissue certificates for the device in the event of certificate expiration or revocation without modifying the ownership voucher, minimizing disruption and ensuring continuity in device management. The onboarding service may also utilize intermediate CAs to issue certificates for organizational flexibility, allowing certificates to be scoped to specific subdomains or estates within an organization.

Moreover, the onboarding service may onboard the device using a certificate that includes wildcard DNS names to define ownership scope across subdomains, supporting scalability and hierarchical ownership structures. Finally, the onboarding service may support dynamic specification of certificate authorities within the ownership voucher, enabling flexible trust models and mitigating risks associated with globally trusted CAs.

FIG. 7 illustrates method 700 performed by a device during secure onboarding, focusing on establishing trust with an onboarding service and integrating into a secure network environment. Method 700 begins at 701 with the initialization of the onboarding process, where the device prepares to establish ownership and communicate with the onboarding service.

At 702, the device generates an ownership voucher. This ownership voucher may include a name corresponding to the prospective owner of the device, which may represent a DNS domain, subdomain, or other identifier specifying the ownership scope. The ownership voucher may serve as the foundational document for validating ownership during the onboarding process. The device may be responsible for properly formatting the ownership voucher and including all necessary information to facilitate validation by the onboarding service.

At 703, once the ownership voucher is generated, the device transmits the ownership voucher to the onboarding service. This transmission may occur over a secure communication channel to preserve the integrity and confidentiality of the ownership voucher. The onboarding service may use the ownership voucher to initiate the process of validating ownership and issuing a certificate.

At 704, the device then receives a certificate from the onboarding service. The certificate is issued by a trusted CA and may include key information such as a custom x509 extension defining the ownership scope and a name corresponding to the prospective owner. The certificate may serve as proof that the onboarding service is authorized by the CA to onboard devices on behalf of the named owner.

At 705, upon receiving the certificate, the device validates the certificate to check its authenticity and integrity. This validation process includes verifying the certificate chain associated with the certificate authority to confirm that the certificate is properly signed and issued by a trusted CA. The device also checks the certificate revocation status using standard revocation mechanisms, such as the OCSP or CRLs).

At 706, after validating the certificate, the device checks that the name in the ownership voucher matches the name specified in the certificate. This verifies that the certificate corresponds to the correct ownership scope and that the onboarding service is authorized to onboard the device on behalf of the named owner. If the names match, the device may proceed to establish trust with the onboarding service.

Trust is established by the device at 707 upon successful validation of the certificate and confirmation of the name match. This allows the device to securely integrate into the network environment managed by the onboarding service. The device may use the validated certificate to authenticate its participation in the network and maintain compliance with the defined ownership scope. Method 700 ends at 708.

In some implementations, the device may store a record of the validation process, including the certificate chain and revocation status, for auditing purposes. This adds traceability and compliance with security standards. Additionally, the device may support mechanisms for revalidating certificates in the event of certificate expiration or revocation, thus promoting continuity in its network participation.

As such, systems and methods described herein provide secure device onboarding by replacing traditional mechanisms based on private ownership credentials with a CA-based framework with TLS-type certificate management. Unlike existing methods that rely on end-customers to manage private credentials, these systems and methods introduce the concept of “named owners,” where ownership is specified by a name, such as a DNS domain, rather than relying on private credentials. This name is attested through certificates issued by trusted Root CAs, enabling onboarding services to prove their authorization via certificates rather than direct possession of private credentials.

Systems and methods described herein may also incorporate custom x509 extensions to define ownership scope, support intermediate CAs for organizational flexibility, and/or provide mechanisms for certificate re-issuance and revocation without requiring changes to endpoint ownership vouchers. Additionally, these systems and methods may allow for the inclusion of multiple Root CAs in ownership vouchers to mitigate risks associated with CA revocation, offering improved security, scalability, and ease of management compared to traditional credential-based systems.

Many techniques disclosed herein provide several advantages over traditional secure onboarding approaches. For example, they introduce the use of names (such as DNS domains) as a mechanism for specifying the owner within an ownership Voucher, rather than relying on private cryptographic keys. Ownership is then attested using a root CA certificate that is already known to the device, thereby establishing a secure and verifiable link between the name and the entity claiming ownership.

To define the scope of ownership, systems and methods described herein may incorporate custom certificate fields at multiple levels: globally, through fields embedded in root CA-issued certificates, and organizationally, through similar fields in Intermediate CA-issued certificates. These extensions allow for precise delineation of ownership boundaries across hierarchical trust models. These systems and methods also enable certain intermediate ownership attributes to be revoked or reissued without necessitating the creation of new endpoint ownership vouchers, which enhances operational flexibility and simplifies lifecycle management. Furthermore, the ability to include multiple Root CAs within an Ownership Voucher serves as a resilience measure, ensuring continued operability in the event of a Root CA revocation.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution by the processor, cause the IHS to:
receive, at an onboarding service, an ownership voucher that includes a name corresponding to a prospective owner of a device;
obtain, by the onboarding service, a certificate issued by a certificate authority (CA);
validate, by the onboarding service, the name in the ownership voucher against a name in the certificate to establish device ownership by the prospective owner; and
onboard the device upon successful validation.

2. The IHS of claim 1, wherein the certificate comprises a custom x509 extension that defines an ownership scope.

3. The IHS of claim 1, wherein the certificate comprises a Domain Name System (DNS) name corresponding to the name.

4. The IHS of claim 1, wherein to validate the name in the ownership voucher against the name in the certificate, the onboarding service is configured to check a certificate chain.

5. The IHS of claim 1, wherein to validate the name in the ownership voucher against the name in the certificate, the onboarding service is configured to check a certificate revocation status.

6. The IHS of claim 1, wherein the device is onboarded independently of any private cryptographic credentials managed by the prospective owner.

7. The IHS of claim 1, wherein the onboarding service is configured to support a plurality of trusted CAs to mitigate risks associated with CA revocation.

8. The IHS of claim 1, wherein the ownership voucher comprises a plurality of names corresponding to multiple prospective owners, and the onboarding service is configured to validate ownership for each name using respective certificates.

9. The IHS of claim 1, wherein the onboarding service is configured to reissue certificates for the device in response to a certificate expiration or revocation without modifying the ownership voucher.

10. The IHS of claim 1, wherein the onboarding service is configured to utilize intermediate CAs to issue certificates.

11. The IHS of claim 1, wherein the onboarding service is configured to onboard the device using a certificate that includes wildcard Domain Name System (DNS) names to define ownership scope across subdomains.

12. The IHS of claim 1, wherein the onboarding service is configured to store a record of the validation, including the certificate chain and revocation status, for auditing purposes.

13. The IHS of claim 1, wherein the onboarding service is configured to support dynamic specification of CAs within the ownership voucher.

14. The IHS of claim 1, wherein the onboarding service is configured to onboard the device using a certificate comprising an x509 extension specifying ownership scope.

15. The IHS of claim 1, wherein the onboarding service allows coexistence of CA-based ownership and private cryptographic credential-based ownership mechanisms.

16. A memory device having program instructions stored thereon that, upon execution by a processor of a device, cause the device to:
generate an ownership voucher that includes a name corresponding to a prospective owner of the device;
transmit the ownership voucher to an onboarding service;
receive a certificate issued by the onboarding service and attested by a Certificate Authority (CA);
validate the certificate;
determine that the name in the ownership voucher matches a name in the certificate; and
establish trust with the onboarding service in response to the determination.

17. The memory device of claim 16, wherein to validate the certificate, the onboarding service is configured to check a certificate chain with the CA.

18. The memory device of claim 16, wherein to validate the certificate, the onboarding service is configured to check a certificate revocation status.

19. A method, comprising:
receiving an ownership voucher that includes a name corresponding to a prospective owner of a device;
obtaining a certificate issued by a certificate authority (CA);
validating the name in the ownership voucher against a name in the certificate to establish device ownership by the prospective owner; and
onboarding the device upon successful validation.

20. The method of claim 19, wherein the device is onboarded independently of any private cryptographic credentials managed by the prospective owner.
